(19) United States
(12) Patent Application Publication
(10) Pub. No.: US 2010/0172601 A1
(43) Pub. Date: Jul. 8, 2010

(54) Covering Mesh Bag for Planting Fruit and Vegetables

(76) Inventor: Ming-Yun Lin, Taipei County (TW)

Correspondence Address: SHOU - HSIN YIN, P.O. BOX 90-3 Taipei, TAIPEI City, 10699, TW

(21) Appl. No.: 12/348,020

(22) Filed: Jan. 2, 2009

(51) Int. Cl. B65D 33/28; B65D 33/16; A01G 13/02

(52) U.S. Cl. 383/41; 383/76; 383/64; 47/24.1

(57) ABSTRACT

A covering mesh bag used for planting fruit and vegetables is disclosed. The covering mesh bag includes a mesh bag and two cords separately disposed along two edges of opening of the mesh bag. Two ends of each of the two cords are outside the mesh bag. There is a zipper at the bottom of the mesh bag. The opening of the mesh bag can be girded by pulling the two cords and the cords can be tied to a branch of a fruit tree or treillage. The zipper is used as a closeable opening for observing the fruitage covered in the mesh bag.

### BACKGROUND OF THE INVENTION

1. Field of the Invention

The invention relates to bags, and more particularly to mesh bags.

2. Description of Related Art

Conventional covering bags usually adopt paper bags. The opening of the paper bag is provided with an iron wire for tying up. There is a hole at the bottom of bag for observing growth of fruit therein. However, the paper bags tend to adhere to each other or to be broken when suffering from a heavy rain or wind. Moreover, the iron wire binding the opening of bag also tends to undo because it only ties the stalk of a fruit up. A special bag made of hard paper, which is used for high mountain pears, are weatherproof, but it is hard to deal with problems arising from a heavy rain or wind. The paper bag covering a fruit must be carefully separated from the fruit. It is very inconvenient and difficult. On the other side, the fruit covered by paper bag can not be observed directly. A suitable time of harvesting fruits tends to be missed. Some farmers adopt a kind of mesh bag for covering fruits. There is, however, only one cord at the opening of the bag for tying stalk of a fruit up. Its tying strength is not solid enough.

### SUMMARY OF THE INVENTION

A primary object of the invention is to provide a mesh bag, which has two cords on the opening thereof for binding the opening and tying a branch or treillage so that the tying strength of the bags can be increased.

Another object of the invention is to provide a mesh bag, which has a zipper disposed at the bottom for observing growth of fruits covered by the bags.

### BRIEF DESCRIPTION OF THE DRAWINGS

The invention is described in more detail, by way of example, with reference to schematic depictions. In the drawings:

FIG. 1 schematically depicts the covering mesh bag according to the present invention;

FIG. 2 illustrates the two cords on the opening edge;

FIG. 3 illustrates a using state of the covering mesh bag tied on a branch of tree; and

FIG. 4 illustrates the opened zipper at the bottom of the mesh bag.

### DETAILED DESCRIPTION OF THE INVENTION

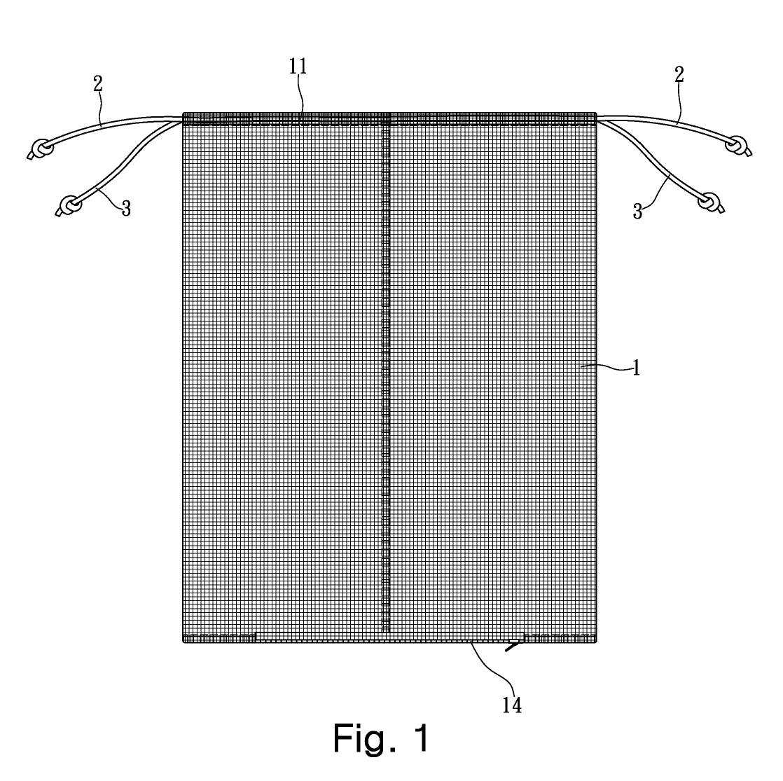

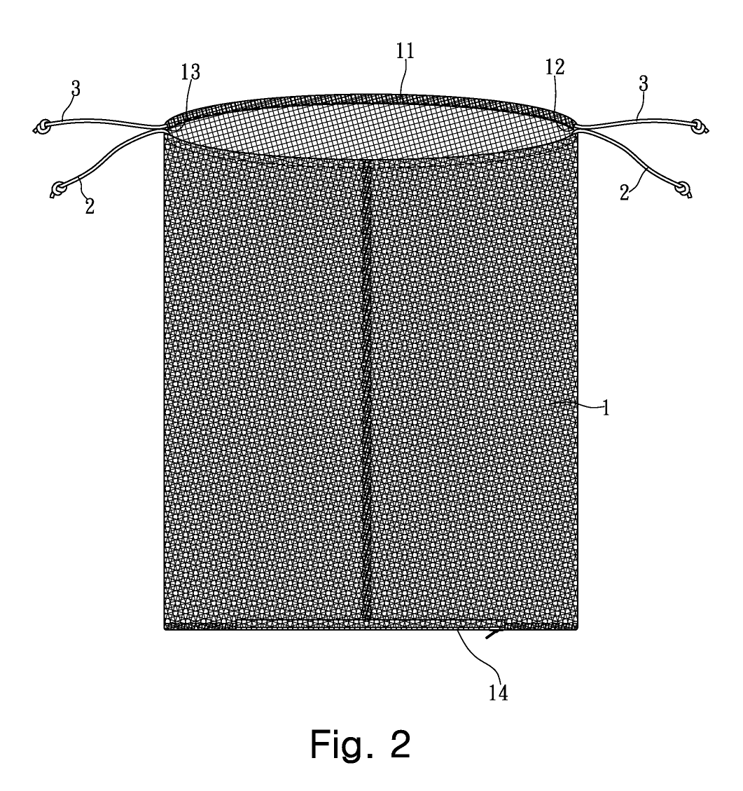

Referring to FIGS. 1 and 2, in a preferred embodiment of the present invention, the covering mesh bag for fruit and vegetables includes a mesh bag 1, two cords 2 and 3 wrapped on the opening edge 11 of the mesh bag, and a zipper 14 at the bottom of the mesh bag 1.

As can be seen in FIG. 2, the opening edge 11 of mesh bag 1 forms two symmetrical channels with two outlets 12 and 13. Zipper 14 is disposed at the bottom of mesh bag 1 as a closeable opening. Two cords 2 and 3 separately pass through the two channels on the opening edge 11 and extend from outlets 12 and 13. Two ends of each of the two cords 2 and 3 are outside the mesh bag 1.

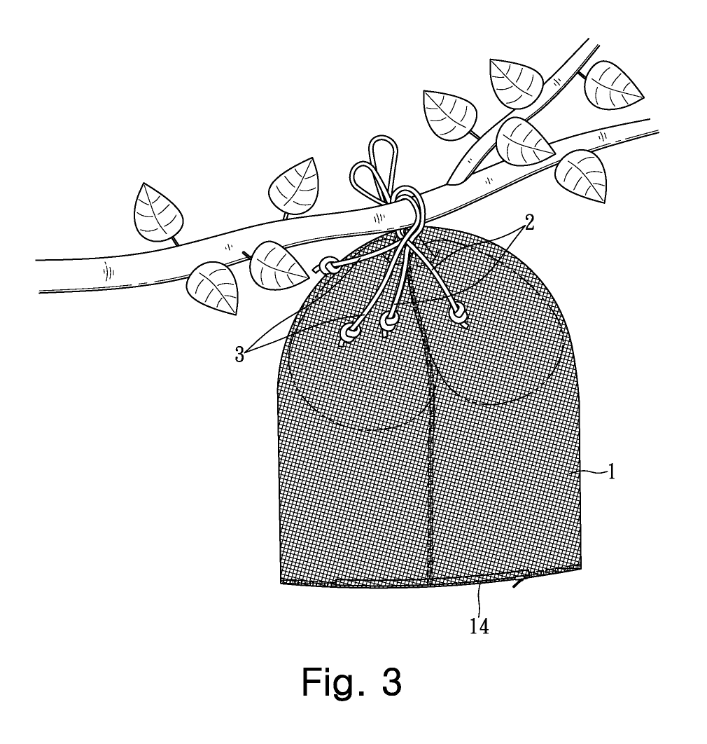

By means of cords 2 and 3 on the opening edge 11 and extending from the outlets 12 and 13, the opening edge 11 can be closely bound or expansively opened. When a fruit is put in the mesh bag 1, the opening edge 11 can be shrunk to close by pulling exterior ends of the cords 2 and 3. The cords 2 and 3 can be crossed mutually and then tied to a branch of a fruit tree as shown in FIG. 3. The stability of the fruit covered by the mesh bag 1 can be improved.

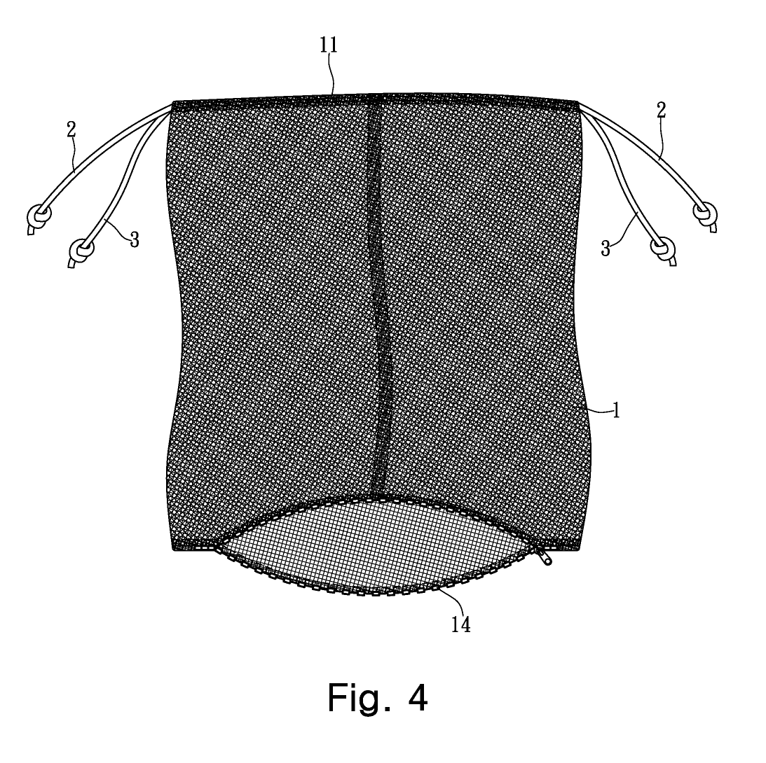

Furthermore, the zipper 14 is arranged at the bottom of mesh bag 1 for being as a closeable opening. When a bunch of fruits are growing in a covering bag, there may be one being precocious or fugacious. The abnormal condition can be easily found out by using the zipper 14 of the covering bag according to the present invention. Those abnormal fruits can also be pluck out through opened zipper 14 as shown in FIG. 4. Therefore, quality fruitage can be more easily obtained than ever.

In sum, the covering mesh bag according to the present invention indeed has the advantages as following:

1. easy and prompt bagging operation:

Because there are two cords 2 and 3 on the opening edge 11 for directly binding, the bagging operation can be easily and promptly performed.

2. increased stability of fruits:

The two cords 2 and 3 can tie a branch of fruit tree or treillage up after the opening edge 11 is bound so that the stability of fruits can be increased.

3. convenient observation:

The mesh bag 1 allows the fruit covered by it to be shone by the sun, and to be observed by tillers. The growth of fruits can be intuited.

4. readily taking abnormalities out:

By means of the zipper 14 disposed at the bottom of mesh bag 1, abnormal fruits bagged in the mesh bag 1 can be easily found out and readily taken out.

5. repeated use:

The mesh bag 1 can be repeatedly used. It is very economical.

Although illustrative embodiment has been shown and described, a wide range of modification, change and substitution is contemplated in the foregoing disclosure and in some instances, some features of the embodiment may be employed without a corresponding use of other features. Accordingly, it is appropriate that the appended claims be construed broadly and in a manner consistent with the scope of the embodiment disclosed herein.

What is claimed is:

1. A covering mesh bag comprising:
a mesh bag having an opening edge and a bottom, the opening edge forming two channels with two outlets; and
two cords separately passing through the two channels and extending from the outlets, and two ends of each of the cords being outside the mesh bag.

2. The covering mesh bag of claim 1, further comprising a closeable opening disposed at bottom of the mesh bag.

3. The covering mesh bag of claim 2, wherein the closeable opening is a zipper.
